(19) United States
(12) Patent Application Publication
(10) Pub. No.: US 2004/0205476 A1
(43) Pub. Date: Oct. 14, 2004

(54) System for referencing digital document from printed copy

(76) Inventor: Timothy Merrick Long, Lindfield NSW (AU)

Correspondence Address: FITZPATRICK CELLA HARPER & SCINTO, 30 ROCKEFELLER PLAZA, NEW YORK, NY, 10112, US

(21) Appl. No.: 10/212,155

(22) Filed: Aug. 6, 2002

(30) Foreign Application Priority Data
Aug. 6, 2001 (AU) PR6800

(51) Int. Cl. G06F 15/00

(52) U.S. Cl. 715/500

(57) ABSTRACT

A method (100) and system (500) is disclosed by which an identifier and a password are incorporated into a document upon printing of the document. The identifier may include a uniform resource locator (URL) for a specific Web site. In use, any person in possession of the printed form of the document, or a photocopy thereof, can, using a standard Web browser application operating on a computer system, retrieve an encrypted electronic copy of the document using the identifier printed on the document. By entering the given password, as also printed on the document, the person can obtain access to the document in its electronic form.

### FIELD OF THE INVENTION

The present invention relates generally to the printing of documents and, in particular, to network access of a digital form of a printed document.

### BACKGROUND

In business environments, printed copies of presentations and other documents are often delivered by hand to people in organisations that do not form part of an intranet of the organisation from which the document originated. Although the document may have some level of confidentiality, in many cases, having given away a printed copy, the originating organisation would be happy to have the or each individual who obtains a copy, to also obtain an electronic copy thereof, if desired. Such an electronic copy may be provided in, say, PDF form.

With existing arrangements, such typically necessitates the recipient contacting the originator, by telephone or e-mail for example, and the originator sending the electronic copy to the recipient by e-mail, or using some portable storage medium, such as a floppy disk or CD-ROM.

Arrangements exists for publishing electronic documents on a Web site. However, this allows unrestricted access to such electronic documents.

### SUMMARY OF THE INVENTION

It is an object of the present invention to substantially overcome, or at least ameliorate, one or more disadvantages of existing arrangements.

According to a first aspect of the present invention, there is provided a method of accessing a digital representation of a printed document, said digital representation being stored at a location on a computer network in an encrypted form, said method being characterised by printing an identifier and a password upon said printed document, said location being determinable from said identifier and said password being operable for decrypting said digital representation upon retrieval thereof from said location.

According to a another aspect of the present invention, there is provided a document processing method comprising the steps of:

(a) obtaining a document intended for printing;

(b) generating a key to be associated with said document;

(c) generating a unique identifier for said document;

(d) incorporating at least said key and said identifier into said document to modify a visual presentation of said document;

(e) printing said modified document including visibly representing said key and said identifier;

(f) processing said modified document to provide an electronic representation thereof, said electronic representation being electronically accessible by way of said key; and

(g) storing said electronic representation at an electronically accessible location determinable from said identifier.

According to a another aspect of the present invention, there is provided a user interface element selectable to cause both printing of a document and to avail electronic access to a representation of said document via said printed document, said printing and availing of access being established according to the method noted above.

According to a another aspect of the present invention, there is provided a document processing system comprising:

first means for generating an identifier and a key;

second means for incorporating said identifier and said key into an electronic document to thus modify a visual presentation of said document;

third means for printing said electronic document, so as to visually present at least said identifier and said key where present therein; and

fourth means for storing said electronic document at an electronically accessible location established at least using said identifier, wherein access to said document at said location is availed using said key.

Other aspects of the invention are also disclosed.

Using the principles disclosed above, a user is able to check a box in a printer driver that signals the print system to:

(i) create an encryption key;

(ii) include the key and a document identifier in a human readable form on the first or each page of the printed document; and

(iii) generate a digital form of the document (eg. PDF), encrypt the digital form with the encryption key, and place the encrypted document on a publicly accessible server.

Any recipient of the document, either the original or photocopy thereof, is then able to visit a web site and provide the identifier and key to obtain the digital form of the document.

### BRIEF DESCRIPTION OF THE DRAWINGS

One or more embodiments of the present invention will now be described with reference to the drawings, in which:

FIG. 1 is a flowchart of a method for document referencing;

FIG. 2A is a representation of a user interface applicable to the method of FIG. 1;

FIG. 2B is a flowchart representing operation of the interface of FIG. 2A;

FIG. 3 is a flowchart of the referencing operations of FIG. 1;

FIGS. 4A to 4C show various examples of the addition of references to various documents; and

FIG. 5 is a schematic block diagram of a general purpose computer system upon which arrangements described can be practiced.

### DETAILED DESCRIPTION INCLUDING BEST MODE

The arrangements to be described provide a method and mechanism by which a reference mark or other indicia may be substantially automatically incorporated into a document upon printing of the document, such that a reader of the printed document may thereafter readily gain access to an electronic copy of the document.

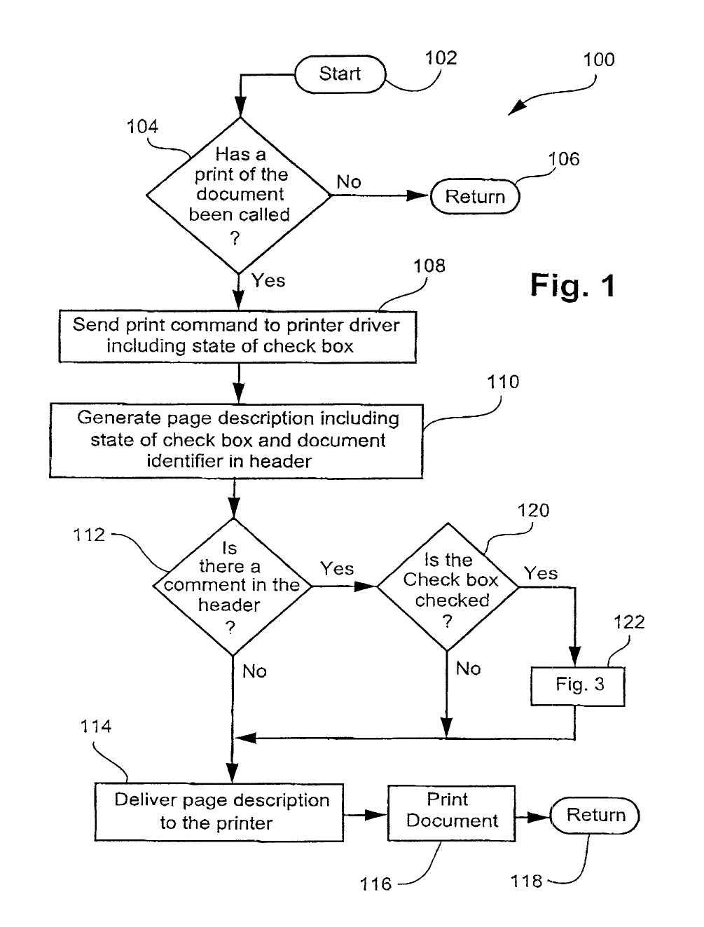

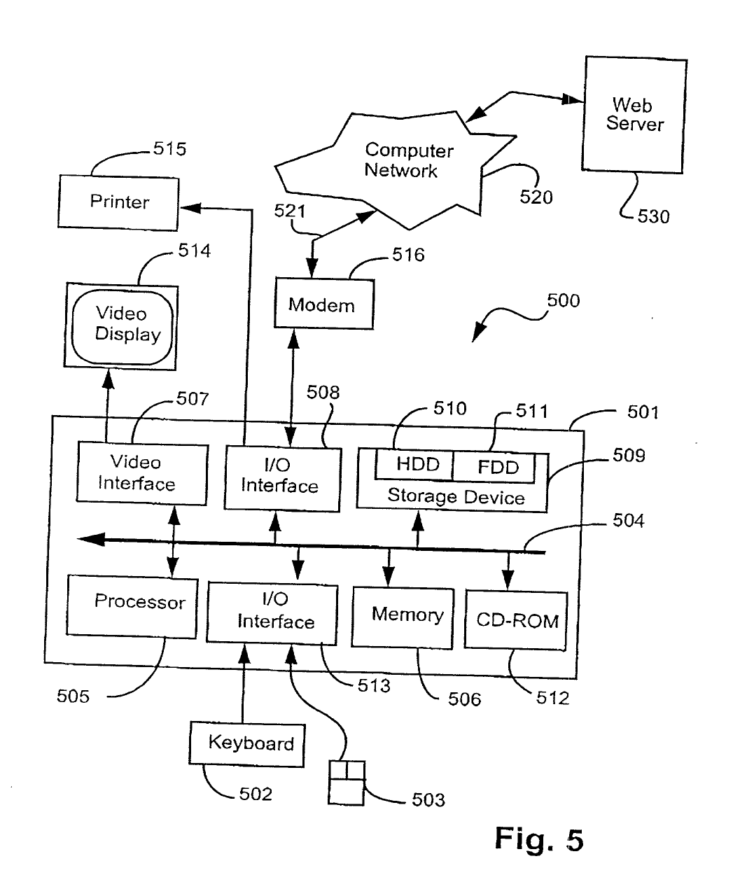

The method and mechanism of such referencing is preferably practiced using a general-purpose computer system 500, such as that shown in FIG. 5 wherein the various processes to be described with reference to FIGS. 1 to 3 may be implemented by way of computer software, such as an application program, executing within the computer system 500. In particular, the steps of method of document referencing are effected by instructions in the software that are carried out by the computer system 500. The instructions may be formed as one or more code modules, each for performing one or more particular tasks. The software may also be divided into two separate parts, in which a first part performs the actual referencing and a second part manages a user interface between the first pair and the user. The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer system 500 preferably effects an advantageous apparatus for document referencing.

The computer system 500 comprises a computer module 501, input devices such as a keyboard 502 and mouse 503, and output devices including a printer 515 and a display device 514. A Modulator-Demodulator (Modem) transceiver device 516 is used by the computer module 501 for communicating to and from a communications network 520, for example connectable via a telephone line 521 or other functional medium. The modem 516 can be used to obtain access to a Wide Area Network (WAN) such as the Internet, or other network systems, such as a Local Area Network (LAN). Connected or otherwise coupled to and therefore accessible via the network 520 is a server computer system 530 which is configured to be publicly accessible, via the Internet for example.

The computer module 501 typically includes at least one processor unit 505, a memory unit 506, for example formed from semiconductor random access memory (RAM) and read only memory (ROM), input/output (I/O) interfaces including a video interface 507, and an I/O interface 513 for the keyboard 502 and mouse 503 and optionally a joystick (not illustrated), and an interface 508 for the modem 516. A storage device 509 is provided and typically includes a hard disk drive 510 and a floppy disk drive 511. A magnetic tape drive (not illustrated) may also be used. A CD-ROM drive 512 is typically provided as a non-volatile source of data. The components 505 to 513 of the computer module 501, typically communicate via an interconnected bus 504 and in a manner which results in a conventional mode of operation of the computer system 500 known to those in the relevant art. Examples of computers on which the described arrangements can be practised include IBM-PC's and compatibles, Sun Sparestations or alike computer systems evolved therefrom.

Typically, the application program is resident on the hard disk drive 510 and read and controlled in its execution by the processor 505, generally within the confines or control of an operating system which manages operation of the computer module 501. Intermediate storage of the application program and any data fetched from the network 520 may be accomplished using the semiconductor memory 506, possibly in concert with the hard disk drive 510. In some instances, the application program may be supplied to the user encoded on a CD-ROM or floppy disk and read via the corresponding drive 512 or 511, or alternatively may be read by the user from the network 520 via the modem device 516. Still further, the software can also be loaded into the computer system 500 from other computer readable media. The term “computer readable medium” as used herein refers to any storage or transmission medium that participates in providing instructions and/or data to the computer system 500 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 501. Examples of transmission media include radio or infra-red transmission channels as well as a network connection to another computer or networked device, and the Internet or Intranets including e-mail transmissions and information recorded on websites and the like.

A method 100 depicting operation of the application program that implements document referencing is shown in the flowchart of FIG. 1. The method 100 is intimately associated with printing of the document and, as such, may form part of a larger application program, such as a word processing or desk top publishing package, for example, operating within the computer module 501. Alternatively, the application program may be a stand-alone module accessible by the word processor application.

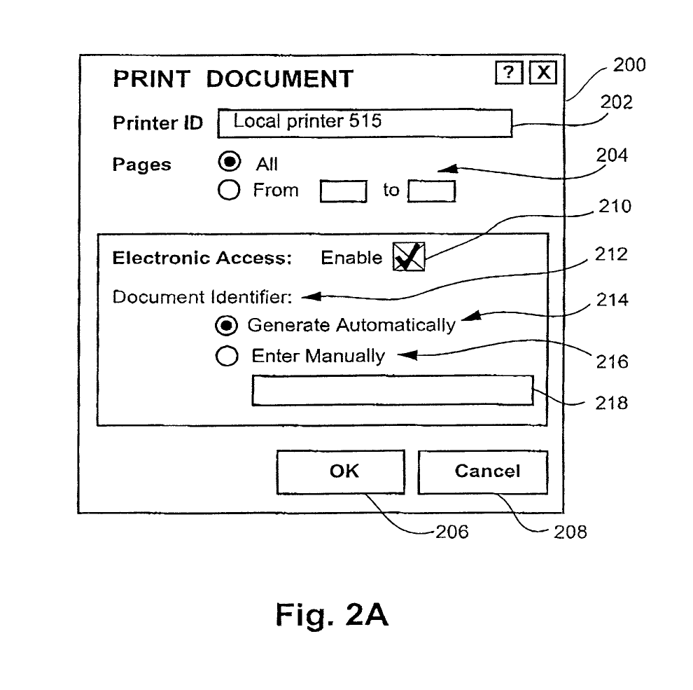

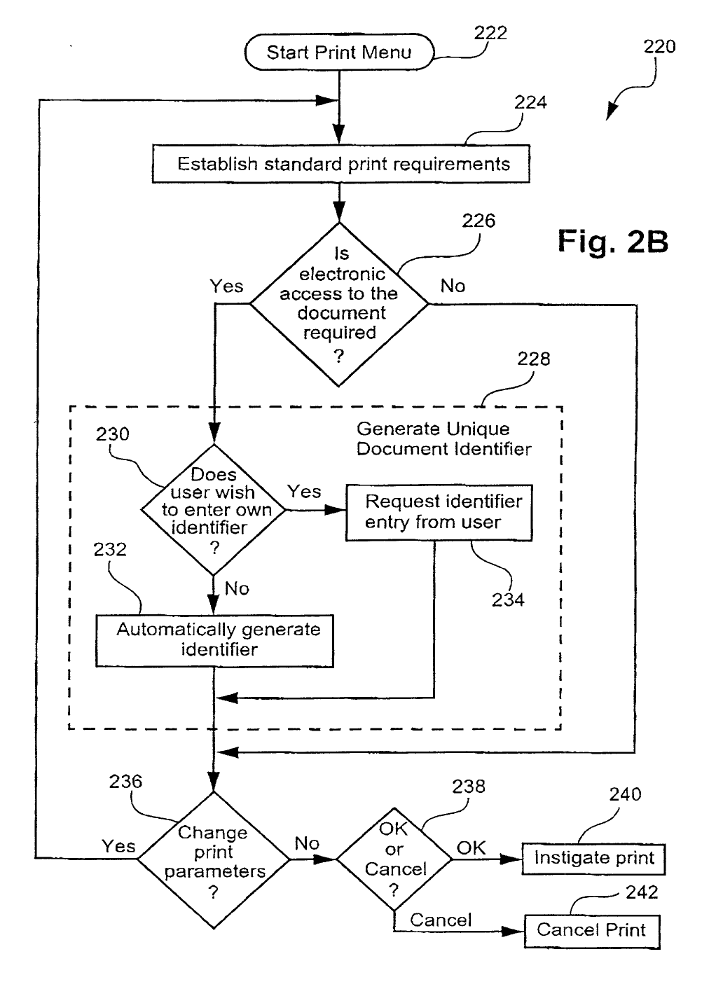

The method 100 is entered when a printing function related to the document in question is activated, for example via the word processing application, this being equivalent to step 102. At step 104 which follows, the method 100 performs a check of whether or not a print of a document has been called via the print menu. An example of a print menu 200 is shown in FIG. 2A, where the menu 200 is configured to operate according to the referencing methods disclosed herein. Operation of the print menu 200 is preferably by way of a method 220 depicted by the flowchart of FIG. 2B.

The menu 200 is activated at a start step 222 and is typically displayed to the user of the computer system 500 via the video display 514 and includes a number of graphical user data entry locations. Initially the user establishes a number of standard print requirements at step 224 by way of the data entry locations. One such data entry location is a printer identifier 202, where the use may specify the name and/or location of printer to be used to print the document. This may be the local printer 515 or another printer (not illustrated) coupled to the network 520. A page range entry 204 is also provided, as are OK and Cancel icons 206 and 208 respectively by which printing is either instigated or cancelled. Where the user selected the Cancel icon 208, step 104 passes control to step 106 which terminates the method 100.

The menu 200 also includes a two-state check-box element 210 which is assessed at step 226 to determine whether electronic access to the document that is to be printed is required. By default the check-box 210 may be un-checked thus ordinarily preventing electronic access. In such a case, control passes from step 226 to step 236 where a change of any of the print parameters is permitted by returning to step 224. Electronic access may be enabled by the user checking or otherwise selecting by the box 210, by pointing and clicking the mouse device 503 for example.

Where electronic access is required, a unique document identifier (ID) is generated at step 228 as seen from 212 in the menu 200. Step 228 as illustrated includes a number of sub-steps. At sub-step 230, the user is invited, by way of the menu 200 to indicate whether or not the user desires to enter its own identifier, or document name. This may be done by selecting either one of the graphical icons denoted as “Enter Manually” 216 or “Generate Automatically” 214, respectively, as seen in FIG. 2A. By default, “Generate Automatically” 214 may be selected in which case sub-step 232 operates to automatically generate the require identifier. Where desired, the user by way of a click of the mouse 503 may select manual entry and sub-step 234 follows where the user enters the relevant identifier into an entry box 218 forming part of the menu 200. The option afforded by sub-step 234 need not be provided, and step 228 may include only the automated generation of the unique document identifier performed by sub-step 232.

Once the unique document ID is created, step 236 follows having the same function as described above. Some or all of the print requirements may be automatically set to default conditions upon establishing the print menu 200 at step 222 or at step 224. Once the print parameters are established, step 238 assesses the user's selection of the OK icon 206 and Cancel icons 208 to either instigate printing at step 240 or cancel printing at step 242.

In preferred implementations, the menu 200 forms part of a user interface of a printer driver of a WINDOWS (trademark of Microsoft Corp.) operating system for a PostScript printer. When the user selects the OK icon 206, step 240, corresponding to “Yes” in step 104 (FIG. 1), causes a print command to be sent at step 108 to the printer driver. Being a software module operating within the computer module 501, the printer driver generates at step 110 a PostScript page description of the document to be printed. This is performed in a traditional fashion for PostScript printing excepting that the page description is formed according to the preferred implementation to also include a specific comment in the header of the PostScript data, that indicates the enabled state of the check-box 210 of the menu 200 and the document identifier established at step 228.

A WINDOWS operating system port monitor, modified according to the method 100, receives the PostScript data generated by the printer driver. The modified port monitor checks at step 112 for the presence of a comment in the header of the PostScript data. If no comment is found, the port monitor at step 114 delivers the PostScript page description data to the specified printer (eg. the local printer 515 as specified in the menu 200) in a traditional fashion where the printer prints the document a step 116 and the method terminates at step 118. Where a comment is found in step 112, step 120 follows where it is determined whether or not the comment specifies that the check-box 210 was checked by the user at the time of instigating the print. If not checked, control passes again to step 114 and printing proceeds in a traditional fashion as described above.

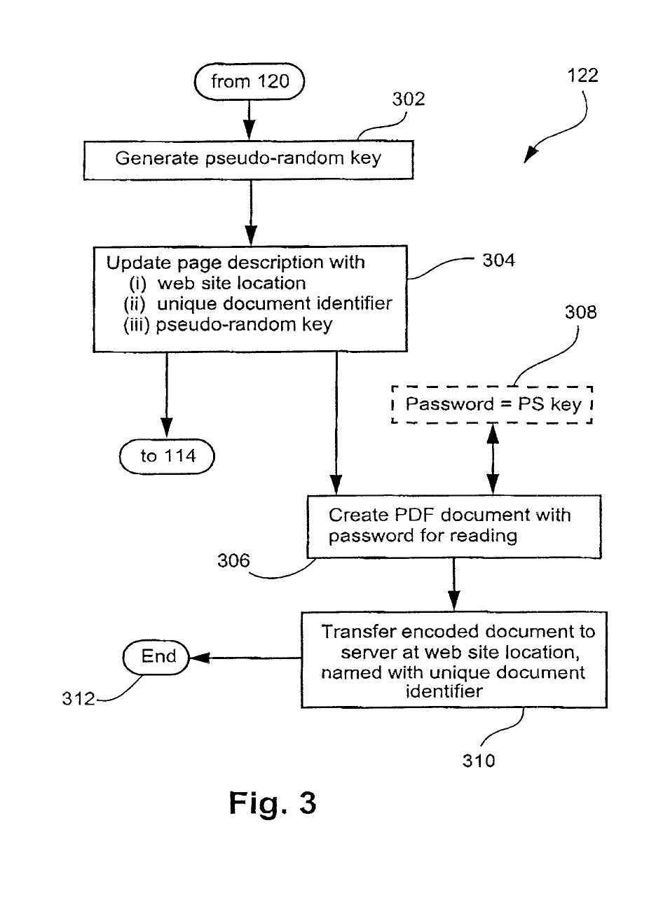

However, if step 120 determines that the specific comment is present and it indicates that the check-box 210 was checked, the port monitor performs step 122, illustrated in detail in FIG. 3.

As seen in FIG. 3, step 122 commences with step 302 where a pseudo-random key is generated. Preferably, the key has a length of at least 48 bits, and is provided in the form of a textual representation. In a preferred implementation, the key is encoded as text character string, where each character is selected from a set of 16 distinct characters that are visually distinct. Alphanumeric characters are preferred, as such may be readily entered using a computer keyboard 502. An example of such a character set is:

A B C D E H J K L M N P S T U W.

Following step 302, the PostScript page description data of the document to be printed is updated at step 304 in such a way that an additional page marking is included at a convenient location of each page to be printed. Such a location can include the footer of the page, such being readily identifiable in many word processing and other applications. Each such additional mark is formed to include a uniform resource locator (URL) for a specific Web site, the unique document ID generated at step 228, and the textual representation of the pseudo-random key generated at step 302. The Web site is preferably that of the publicly accessible server 530 at which an electronic copy of the document being printed may be retained, as described below.

From step 304, the updated PostScript page description data is then delivered to the printer, via step 114, to effect actual printing of the document incorporating the additional marking, this occurring via the traditional further processing described above with reference to FIG. 1.

Also from step 304, the updated PostScript data is examined at step 306, and a PDF format electronic document is then generated. PDF is a document format developed by Adobe Systems Inc. of the USA. The PDF document represents substantially the same document is that being printed, although in an encoded (PDF) form. The electronic document is preferably protected using a standard PDF security mechanism (based on the RC4 method from RSA Corporation), such that the entry of a password is required to read the electronic document. As depicted in FIG. 3 at point 308, the password required for such access is the textual representation of the pseudo-random key generated at step 302.

The password protected encoded document is then, at step 310, transferred to the Web server 530 at the specified web site. Such transfer may be performed by use of the File Transfer Protocol (FTP). The transferred encoded PDF document is named in its residence on the server 530 according to the unique document ID generated at step 228.

Once step 310 is completed, the port monitor then continues normal operation and step 122 concludes at step 312.

In use, any person in possession of the printed form of the document, or a photocopy thereof, can, using a standard Web browser application operating on a computer system, electronically source the encoded PDF document by using the identifying URL and unique document ID printed on the document. By entering the given password, as also printed on the document, the person can obtain access to the document in its electronic form.

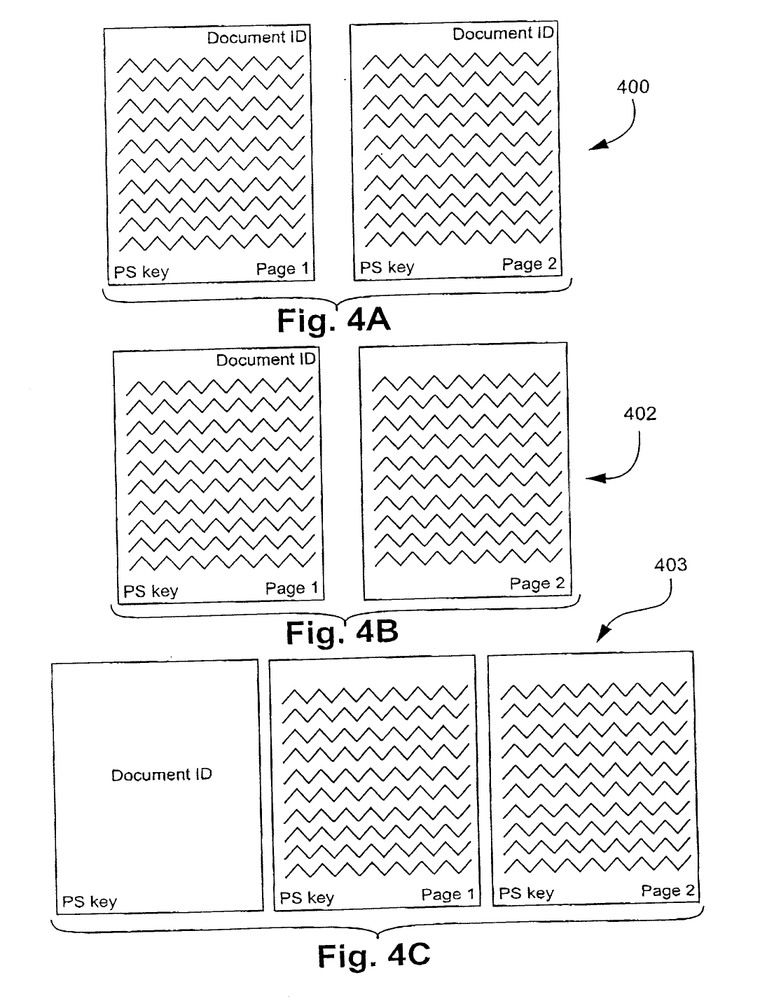

FIGS. 4A to 4C show examples of printed documents formed according to the arrangements described. In FIG. 4A, a document 400 is shown which includes the pseudo-random (PS) key in the footer of each page, associated with the page number, and the unique document ID in the header of each page. In an alternative implementation shown in FIG. 4B, the mark identifying the document ID and access key is only printed on the first page of a document 402. In a further alternative, the marks are printed only on a cover page printed in addition to the body pages of the document 404. Specifically, in each of the examples of FIGS. 4A to 4C, the “Document ID” depicted may be a single string of characters representing a combination of the Web site address and the unique document identifier. Further, in some implementations, the Web site address may be integrated with the unique document identifier, where the “Document ID” as shown may be of the form:

http:\\www.servername.com/ . . . /public_documents/unique_document_identifier.

The arrangements and methods described above can be modified or altered to effect the same utility. For example, the PostScript data may be examined, and the PDF format electronic document is generated therefrom. The additional page marking may then be included in the PDF document. Also, the operations described above as occurring in a WINDOWS system port monitor, may be instead performed in a PostScript compatible printer. In a further alternative, the operations described above as occurring in a WINDOWS system port monitor, may be instead performed in the printer driver.

### INDUSTRIAL APPLICABILITY

The arrangements described are applicable to the computer and data processing industries and particularly to word processing and desk top publishing applications for the distribution of documents in both paper and electronic forms.

The foregoing describes only some embodiments of the present invention, and modifications and/or changes can be made thereto without departing from the scope and spirit of the invention, the embodiments being illustrative and not restrictive.

I claim:

1. A method of accessing a digital representation of a printed document, said digital representation being stored at a location on a computer network in an encrypted form, said method being characterised by printing an identifier and a password upon said printed document, said location being determinable from said identifier and said password being operable for decrypting said digital representation upon retrieval thereof from said location.

2. A method according to claim 1, said method being operable upon a printing system incorporating a facility for establishment of said digital representation, and for storing said encrypted form of said digital representation on said computer network.

3. A method according to claim 2 wherein said printing system comprises a user interface element, said method comprising steps for user enablement or disablement of said establishment via said user interface element.

4. A method according to claim 1 wherein said identifier and said password are in human readable form.

5. A method according to claim 1 wherein said location is represented by a computer network address and said computer network address is determinable from said identifier.

6. A document processing method comprising the steps of:
(a) obtaining a document intended for printing;
(b) generating a key to be associated with said document;
(c) generating a unique identifier for said document;
(d) incorporating at least said key and said identifier into said document to modify a visual presentation of said document;
(e) printing said modified document including visibly representing said key and said identifier;
(f) processing said modified document to provide an electronic representation thereof, said electronic representation being electronically accessible by way of said key; and
(g) storing said electronic representation at an electronically accessible location determinable from said identifier.

7. A method according to claim 6 wherein said method is instigated via a print menu associated with said document intended for printing.

8. A method according to claim 7 wherein said menu comprises a user selectable field via which said method is instigated.

9. A method according to claim 8 wherein step (a) comprises generating a page description of said document, said page description including a state of said user selectable field.

10. A method according to claim 9 further comprising the step of
(aa) examining a state of said field;
(ab) if said field is not set, printing said document and terminating said method; and
(ac) if said field is set, proceeding to step (b).

11. A method according to claim 6 wherein step (b) comprises generating said key in a pseudo-random manner and representing said key using a predetermined set of visually distinct characters.

12. A method according to claim 11 wherein said characters are alphanumeric characters.

13. A method according to claim 6 wherein step (c) comprises automatically generating said unique identifier.

14. A method according to claim 6 wherein step (c) comprises receiving said unique identifier from a user input.

15. A method according to claim 6 wherein step (d) comprises incorporating said key and said identifier into at least one of a header and/or footer of said modified document.

16. A method according to claim 6 wherein step (f) comprises encoding said modified document to an electronic form wherein said key forms a password required to read said electronic form.

17. A method according to claim 16 wherein said electronic representation comprises a PDF document.

18. A method according to claim 6 wherein step (d) comprises incorporating a computer network address into said document and step (g) comprises storing said electronic representation at said computer network address, said computer network address being determinable from said printed document.

19. A method according to claim 6 wherein step (g) comprises storing said electronic representation at a computer network address, said computer network address being determinable from said unique identifier.

20. A document processing system operable according to the method or any one of claims 1 to 19.

21. A user interface element selectable to cause both printing of a document and to avail electronic access to a representation of said document via said printed document, said printing and availing of access being established according to the method of any one of claims 1 to 19.

22. A computer program element comprising computer program code means to make a computer execute a procedure to process a document according to the method of any one of claims 1 to 19.

23. A computer readable medium comprising a computer program element according to claim 22.

24. A document printed according to the method of any one of claims 1 to 19.

25. An electronically accessible document formed according to the method of any one of claims 1 to 19.

26. A document processing system comprising:
first means for generating an identifier and a key;
second means for incorporating said identifier and said key into an electronic document to thus modify a visual presentation of said document;
third means for printing said electronic document, so as to visually present at least said identifier and said key where present therein; and
fourth means for storing said electronic document at an electronically accessible location established at least using said identifier, wherein access to said document at said location is availed using said key.

27. A system according to claim 26 wherein said fourth means encodes said electronic document using said key prior to storage of said encoded electronic document at said location.

28. A system according to claim 26 wherein said system comprises a printing system.

29. A system according to claim 26 further comprising a user interface by which a user can either enable or disable operation of at least said first, second and fourth means.

30. A system according to claim 29 wherein said user interface comprises a print menu displayable to the user via a computer system, said menu comprising an icon for asserting said enablement or disablement.

31. A system according to claim 30 wherein said print menu comprises means for user selection of one of automated generation of said identifier by said computer system or manual entry of said identifier by the user.

32. A system according to claim 29 wherein said key is automatically generated by said computer system.

33. A system according to claim 26 wherein said electronically accessible location comprises a computer network address and said identifier forms at least a name of said electronic document as stored at said network address.
